(19) United States
(12) Patent Application Publication
(10) Pub. No.: US 2005/0004955 A1
(43) Pub. Date: Jan. 6, 2005

(54) System and method for synchronous maintenance of remote template files

(76) Inventors: Chung-I Lee, Tu-chen (TW); Bao Sheng Luo, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/885,912

(22) Filed: Jul. 6, 2004

(30) Foreign Application Priority Data
Jul. 4, 2003 (TW) 92118398

(51) Int. Cl. G06F 17/30; G06F 7/00

(52) U.S. Cl. 707/203; 707/101; 707/200

(57) ABSTRACT

A three-tier network structure system for synchronous maintenance of remote template files (50) includes a template interface module (20), a synchronize module (21), and a record file (22). A method for synchronous maintenance of remote template files includes: (a) selecting a plurality of remote application servers (6) for synchronous maintenance; (b) recording names of the remote application servers in the record file; (c) synchronously maintaining remote template files in the remote application servers; and (d) each of the remote application servers sending a remote message regarding successful maintenance to a client (4).

### BACKGROUND OF THE INVENTION

1. Field of the Invention

The present invention relates to a system and method for helping users to maintain electronic document files, and particularly to a system and method for helping users to synchronously maintain template files in remote databases via an electronic communications network, the template files being usable as standards for document writing.

2. Description of Related Art

Electronic and hardcopy document management is becoming increasingly important in the so-called “information age.” Generally, electronic document management includes document generation and maintenance. Currently, word processing packages are popularly used for document generation. When writers draft special and professional documents such as legal documents, they normally have to follow particular formats and rules. In particular, templates are used for guiding junior writers to draft documents according to the required formats and rules.

The art of document management is disclosed in U.S. Pat. No. 6,098,070 issued on Aug. 1, 2000 and entitled “Case Management for a Personal Injury Plaintiffs Law Office Using a Relational Database.” This patent discloses a system for an electronic case manager for a personal injury plaintiff's law office in which client and defendant level data related to an injury incident are collected and organized in an efficient manner. However, the system does not provide template files for helping junior members of the law office write relevant documents needed in the cases. The junior members' drafting may need extensive and time-consuming revision.

Even when electronic template files are provided in a law office, a large law office may have several branches located at various remote places. Copies of the template files need to be provided at each remote site. Sometimes, users at the various sites need to modify a template file, for example by changing certain rules as to writing. This leads to the situation in which one copy of the template at one site is inconsistent with other copies of the same template at other sites. There is no known system or method which efficiently helps users to synchronously maintain remote copies of templates.

### SUMMARY OF THE INVENTION

An objective of the present invention is to provide a system and method for efficiently helping users to synchronously maintain a local file and a plurality of remote files.

Another objective of the present invention is to provide a system and method for helping users to synchronously maintain a local template file and a plurality of remote template files.

To accomplish the above objectives, a three-tiered network structure system is provided for helping users synchronously maintain a plurality of remote template files via a network. The system comprises a record file, a template interface module, and a synchronize module. The record file is provided for recording names of a plurality of local template files and their corresponding remote application servers. The template interface module provides a template interface, by which a plurality of function entries is provided for users to perform synchronous maintenance of remote template files. The function entries comprise a create synchronization function, a cancel synchronization function, and a rerun synchronization function. The synchronize module is connected to the template interface module, and is for executing the function entries. The synchronize module comprises a create sub-module, a cancel sub-module, and a rerun sub-module. The create sub-module is programmed to accomplish the create synchronization function by selecting a local template file and its corresponding remote application servers. Accordingly, the create sub-module records names of the local template files and names of the corresponding remote application servers in the record file. The cancel sub-module is programmed to accomplish the cancel synchronization function for timely canceling of synchronous maintenance if an error is found after the create synchronization function is invoked. The rerun sub-module is programmed to accomplish the rerun synchronization function by accessing the record file.

The present invention also provides a method for synchronous maintenance of remote template files. The method is for synchronous maintenance of remote template files by using a three-tiered network structure providing a template interface on a client. The method comprises: (a) selecting a plurality of remote application servers for synchronous maintenance; (b) recording names of the remote application servers in a record file; (c) synchronously maintaining remote template files in the remote application servers; and (d) each of the remote application servers sending a remote message regarding successful maintenance to the client.

Further, the present invention provides a method for helping users synchronously rerun maintenance of a plurality of remote template files based on a three-tier network structure providing a template interface on a client, the method comprising: (a) accessing a record file to obtain names of remote application servers for rerunning synchronous maintenance; (b) synchronously maintaining remote template files in the remote application servers; and (c) each of the remote application servers sending a remote message regarding successful maintenance to the client.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware infrastructure of a system for synchronous maintenance of remote template files in accordance with the present invention;

FIG. 2 is a block diagram of main function units of the system of FIG. 1;

FIG. 3 is a block diagram of a synchronize module of a local application server of FIG. 2; and

FIG. 4 is a flowchart of a method for synchronous maintenance of remote template files in accordance with the present invention.

### DETAILED DESCRIPTION OF THE INVENTION

Reference will now be made to the drawing figures to describe the present invention in detail.

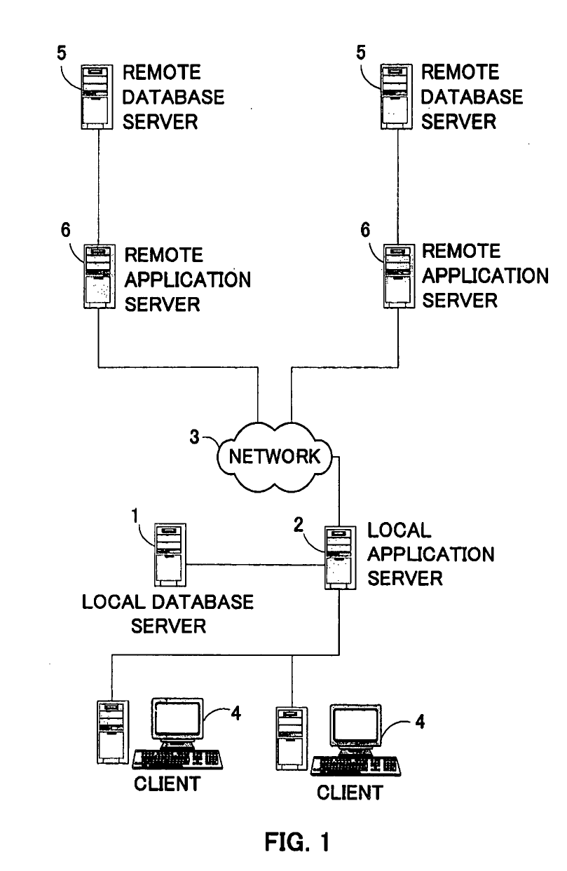

FIG. 1 is a schematic diagram of hardware infrastructure of a system for synchronous maintenance of remote template files in accordance with the present invention. The hardware infrastructure comprises a local database server 1, a local application server 2, an electronic communications network 3, a plurality of clients 4, a plurality of remote database servers 5, and a plurality of remote application servers 6. The local database server 1 is used for storing relevant document files of cases. The local application server 2 connects to the local database server 1 and the clients 4. The local application server 2 is used for electronically visiting the local database server 1 to access relevant document files of cases, and for providing a user interface on each client 4. Each of the remote application servers 6 connects to a corresponding remote database server 5, which stores relevant document files of cases. Each remote application server 6 is used for electronically visiting the corresponding remote database server 5 to access the relevant document files of cases.

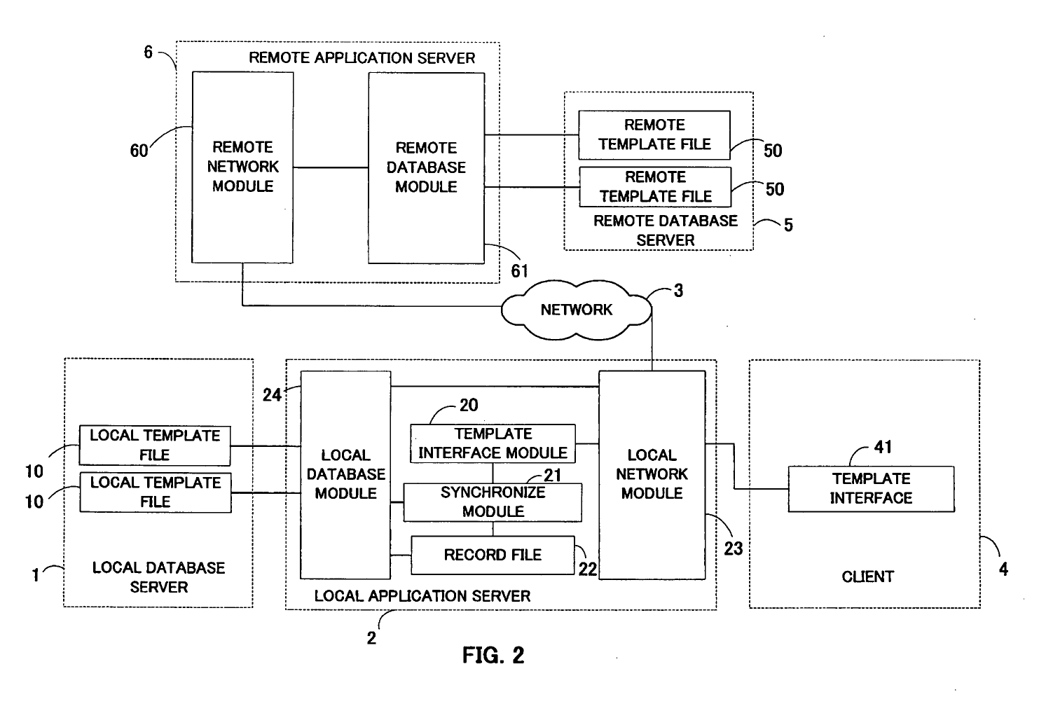

FIG. 2 is a block diagram of main function units of the system for synchronous maintenance of remote template files, but showing only one remote application server 6, one remote database server 5 and one client 4. The local database server 1 comprises a plurality of local template files 10. Each local template file 10 is an electronic document template. The template provides rules for helping users to make relevant document files of cases. The electronic document template can be a text format file of Microsoft Word or other application software.

Consequently, the local application server 2 comprises a template interface module 20, a synchronize module 21, a record file 22, a local network module 23, and a local database module 24. The template interface module 20 provides a template interface 41 on the client 4 via a local network module 23. The template interface 41 provides several function entries for users. The function entries comprise a create synchronization function, a rerun synchronization function, and a cancel synchronization function. The synchronize module 21 connects to the template interface module 20 and the local database module 24, and is used for finishing the function entries provided by the template interface module 20. The record file 22 is used for recording names of local template files 10, and names of corresponding remote application servers 6 to which local template files 10 have been uploaded. Therefore, a user who wants to synchronously maintain remote template files 50 can check the record file 22 to decide whether to execute the create synchronization function or rerun synchronization function on the template interface 41. The local network module 23 of local application server 2 connects to the remote application servers 6 and clients 4 via the network 3 for data communication. The local database module 24 is used for helping users to maintain the local template files 10 of the local database server 1.

Each remote template file 50 is comprised in the remote database server 5, and is an electronic document template. The electronic document template provides rules for helping users to make relevant document files of cases. The electronic document template can be in the form of a text file format based on Microsoft Word or other application software. In present invention, the remote template file 50 is a copy of a corresponding local template file 10 after synchronous maintenance. The remote application server 6 comprises a remote network module 60 and a remote database module 61. The remote network module 60 connects to the local network module 23 via the network 3, for data communication. The remote database module 61 connects to the local database module 24 via the remote network module 60, for facilitating synchronous maintenance. Accordingly, the term “maintain” includes to transport a local template file 10 from the local database server 1 via the local database module 24 to the remote database module 61, for uploading to the remote database server 5 by way of replacing a corresponding remote template file 50.

Alternatively, the synchronize module 21 may send a synchronous maintenance message or a cancel maintenance message to the local database module 24. In the case of a synchronous maintenance message, the local database module 24 then sends a plurality of remote maintenance messages and local template files 10 to the remote database modules 61 of corresponding remote application servers 6 for synchronous maintenance. In the case of a cancel maintenance message, the local database module 24 then passes the cancel message to the remote database modules 61 of corresponding remote application servers 6 to stop synchronous maintenance.

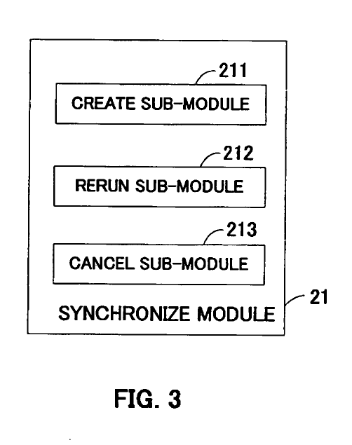

FIG. 3 is a schematic diagram of the synchronize module 21 of the local application server 2. The synchronize module 21 comprises a create sub-module 211, a rerun sub-module 212, and a cancel sub-module 213. The create sub-module 211 is programmed for providing the create synchronization function. The rerun sub-module 212 is programmed for providing the rerun synchronization function. The cancel sub-module 213 is programmed for providing the cancel synchronization function.

Consequently, the template interface 41 on the client 4 provides function entries comprising a create synchronization function, a rerun synchronization function, and a cancel synchronization function. A user can launch the create synchronization function entry to select several remote application servers 6 via the template interface 41. The template interface module 20 then connects to the create sub-module 211 for sending a synchronous maintenance message to the local database module 24, and records names of selected remote application servers 6 in the record file 22. The synchronous maintenance message includes names of selected remote application servers 6 for synchronous maintenance.

Further, before the user launches the create synchronization function to select several remote application servers 6, he/she can access the record file 22 to check the names of remote application servers 6 that have been synchronously maintained. Based on the record file 22, the user can decide to launch the create synchronization function to re-select remote application servers 6, or launch the rerun synchronization function only. If the user launches the rerun synchronization function only, the rerun synchronization function accesses the record file 22 and also sends a synchronous maintenance message to the local database module 24. The synchronous maintenance message includes names of remote application servers 6 recorded in the record file 22.

Once synchronous maintenance is finished, each remote application server 6 automatically sends a message back to the local application server 2 to notify the user that the maintenance was successful. However, if the user finds an error (e.g. wrong version) regarding the local template file 10 before said message is received, he/she can launch the cancel synchronization function. The template interface module 20 then connects to the cancel sub-module 213 for sending a cancel message to the remote application servers 6 to stop the maintenance.

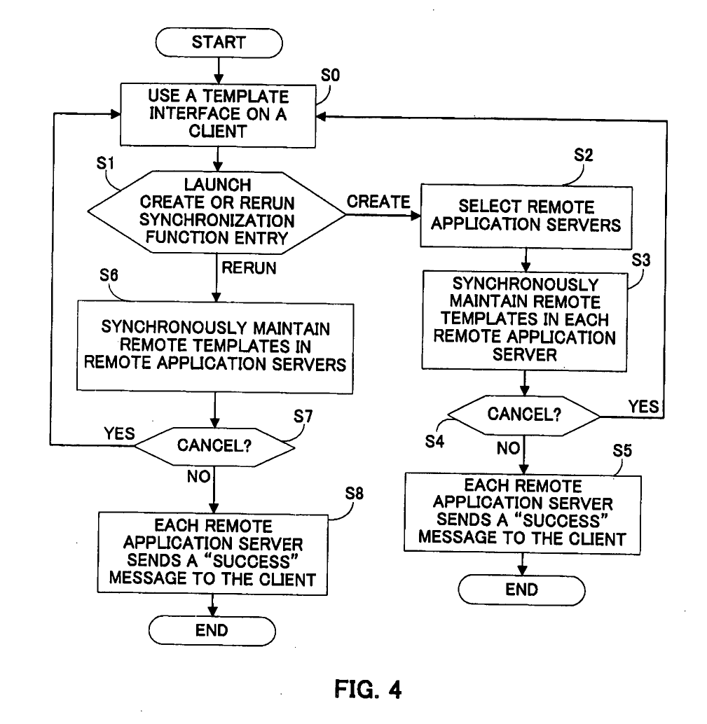

FIG. 4 is a flowchart of a preferred method for synchronous maintenance of remote template files in accordance with the present invention. The method is implemented using the above-described system for synchronous maintenance of remote template files. Said system is a three-tier network structure providing the template interface 41 on a client 4 and the local application server 2, for helping a user to synchronize remote template files 50 via the network 3. In step S0, the user uses the template interface 41 on the client 4 for maintaining a local template file 10 and the remote template files 50. Typically, this involves uploading a new local template file 10 to the local database server 1 to replace an existing local template file 10 in the local database server 1. In step S1, the user decides to launch the create synchronization function entry or rerun synchronization function entry, based on information in the record file 22. If the user launches the rerun synchronization function entry, the procedure goes to step S6 described below. If the user launches the create synchronization function entry, in step S2, the user selects remote application servers 6 for synchronous maintenance on the template interface 41, and the template interface module 20 registers names of the selected remote application servers 6 for sending to the synchronize module 21. In step S3, the synchronize module 21 sends a synchronous maintenance message to the local database module 24. Accordingly, the local database module 24 sends a remote maintenance message and the local template file 10 to each selected remote application server 6 for synchronous maintenance. If any error (e.g. wrong version) is found in the local template file 10, in step S4, the users decides whether to launch the cancel synchronization function to cancel the maintenance. If the user launches the cancel synchronization function, the procedure goes back to step S0 described above. If the user does not launch the cancel synchronization function, in step S5, each remote application server 6 automatically sends a message back to the local application server 2 notifying the user that the maintenance was successful.

In step S6, the user launches the rerun synchronization function to access names of remote application servers 6 recorded in the record file 22 for synchronous maintenance. Accordingly, the synchronize module 21 sends a synchronous maintenance message to the local database module 24. In addition, the local database module 24 sends a remote maintenance message and the local template file 10 to each remote application server 6 for synchronous maintenance. If any error (e.g. wrong version) is found in the local template file 10, in step S7, the user decides whether to launch the cancel synchronization function to cancel the maintenance. If the user launches the cancel synchronization function, the procedure goes back to step S0 described above. If the user does not launch the cancel synchronization function, in step S8, each remote application server 6 automatically sends a message back to the local application server 2 notifying the user that the maintenance was successful.

The invention has been described in terms of certain preferred and alternative embodiments which are representative of only some of the various ways in which the basic concepts of the invention may be implemented. Implementation of the inventive concepts which may occur to those of ordinary skill in the art are within the scope of the invention as defined by the accompanying claims and allowable equivalents thereof.

1. A three-tiered network structure system for synchronous maintenance of remote template files, comprising:
a record file for recording names of a plurality of local template files and corresponding remote application servers that each have a remote template file in accordance with a respective local template file;
a template interface module for providing a template interface for clients, wherein the template interface provides a plurality of function entries for synchronous maintenance, and the function entries comprise a create synchronization function and a cancel synchronization function; and
a synchronize module connected to the template interface module for accomplishing the function entries, comprising:
a create sub-module programmed to accomplish the create synchronization function by selecting a local template file and its corresponding remote application servers, and to record names of the local template file and the remote application servers in the record file; and
a cancel sub-module programmed to accomplish the cancel synchronization function for timely canceling of synchronous maintenance after execution of the create synchronization function.

2. The system for synchronous maintenance of remote template files as claimed in claim 1, wherein the synchronous maintenance comprises the selected local template file being maintained in a local database server, and a maintenance message and the local template file being transported to a plurality of remote application servers at the same time for remote template file maintenance.

3. The system for synchronous maintenance of remote template files as claimed in claim 2, wherein the maintenance message is used for notifying each of the remote application servers to upload the local template file in order to replace the corresponding remote template file.

4. The system for synchronous maintenance of remote template files as claimed in claim 3, wherein the maintenance of the selected local template file comprises uploading a new local template file to the local database server to replace an existing local template file in the local database server.

5. The system for synchronous maintenance of remote template files as claimed in claim 1, wherein the function entries of the template interface further comprise a rerun synchronization function, and the synchronize module further comprises a rerun sub-module programmed to accomplish the rerun synchronization function by accessing the record file.

6. A method for synchronously maintaining a plurality of remote template files based on a three-tier network structure providing a template interface on a client, the method comprising:
selecting a plurality of remote application servers for synchronous maintenance;
recording names of the remote application servers in a record file;
synchronously maintaining remote template files in the remote application servers; and
each of the remote application servers sending a remote message regarding successful maintenance to the client.

7. The method for synchronous maintenance of remote template files as claimed in claim 6, further comprising the step of canceling synchronous maintenance before all the remote messages have been sent to the client.

8. The method for synchronous maintenance of remote template files as claimed in claim 6, wherein the synchronous maintenance comprises the steps of maintaining a local template file in a local database server, and transporting a maintenance message and the local template file to each of the remote application servers at the same time for maintenance of the remote template files.

9. The method for synchronous maintenance of remote template files as claimed in claim 8, wherein the maintenance message is used for notifying each of the remote application servers to upload the local template file in order to replace the corresponding remote template file.

10. The method for synchronous maintenance of remote template files as claimed in claim 9, wherein the step of maintaining a local template file in a local database server comprises uploading a new local template file to the local database server to replace an existing local template file in the local database server.

11. A method for synchronously rerunning maintenance of a plurality of remote template files based on a three-tier network structure providing a template interface on a client, the method comprising:
accessing a record file to obtain names of remote application servers for rerunning synchronous maintenance;
synchronously maintaining remote template files in the remote application servers; and
each of the remote application servers sending a remote message regarding successful maintenance to the client.

12. The method for synchronous maintenance of remote template files as claimed in claim 11, further comprising the step of canceling synchronous maintenance before all the remote messages have been sent to the client.

13. The method for synchronous maintenance of remote template files as claimed in claim 11, wherein the synchronous maintenance comprises the steps of maintaining a local template file in a local database server, and transporting a maintenance message and the local template file to each of the remote application servers at the same time for maintenance of the remote template files.

14. The method for synchronous maintenance of remote template files as claimed in claim 11, wherein the maintenance message is used for notifying each of the remote application servers to upload the local template file in order to replace the corresponding remote template file.

15. The method for synchronous maintenance of remote template files as claimed in claim 13, wherein the step of maintaining a local template file in a local database server comprises uploading a new local template file to the local database server to replace an existing local template file in the local database server.
